(19) United States
(12) Patent Application Publication
(10) Pub. No.: US 2015/0192896 A1
(43) Pub. Date: Jul. 9, 2015

(54) LASER PRINTER WITH DISPOSABLE DEBRIS COLLECTION AND EXHAUST DUCT

(71) Applicant: Primera Technology, Inc., Minneapolis, MN (US)

(72) Inventors: Todd A. Britz, Maple Grove, MN (US); Robert P. Cummins, Deephaven, MN (US)

(21) Appl. No.: 14/404,833

(22) PCT Filed: Jun. 13, 2013
(86) PCT No.: PCT/US13/45637

§ 371 Date: Dec. 1, 2014

Related U.S. Application Data
(60) Provisional application No. 61/667,192, filed on Jul. 2, 2012.

(51) Int. Cl. G03G 21/20; B01D 45/04

(52) U.S. Cl. CPC G03G 21/206; B01D 45/04

(57) ABSTRACT

A laser printer including a disposable debris collection and exhaust duct, and an imaging region at which a laser beam is imaged onto a medium being printed, and a laser system for producing the laser beam and scanning the laser beam across the imaging region. The debris collection duct collects debris produced when the laser beam is imaged onto the medium, and comprises a collection region having a laser beam window, a collection opening in communication with the imaging region, an input port coupled to a source of clean air, and an exhaust port coupled to a source of relatively low pressure on an end of the duct opposite the collection opening from the input port. The laser beam is imaged onto the medium through the laser beam window and the collection opening. Debris produced during printing enters the duct through the collection opening and exits through the exhaust port.

### BACKGROUND

The present invention relates generally to laser-based devices such as printers and other image forming devices. In particular, embodiments of the invention are debris and exhaust collection ducts for use in connection with laser-based devices.

Laser printers and other laser-based image forming devices scan or otherwise move a laser beam across a medium during the image forming process. The scanned medium can be the medium being printed (e.g., ablation-type label stock) or an intermediate imaging medium (e.g., an electrostatic drum). Debris such as fumes, gases and particulate matter can be produced during these imaging processes. This debris can be exhausted and filtered by fume extraction and filtration systems.

There remains, however, a continuing need for improved laser-based image forming devices. In particular, there is a need for such devices that enable the debris produced during the image forming process to be effectively and efficiently exhausted.

### SUMMARY

An image forming device including a debris collection duct. In one embodiment the image forming device is a laser printer including an imaging region at which a laser beam is imaged onto a medium and a system for producing the laser beam and optionally to cause the laser beam to scan the imaging region. The debris collection duct collects debris (e.g., fumes, gas and/or particulate) produced when the laser beam is imaged onto the medium. In one embodiment the debris collection duct comprises a collection region having a laser beam window into which the laser beam can be directed, and a collection opening in communication with the imaging region. The laser beam can be imaged onto the medium through the laser beam window and the collection opening, and the debris can enter the duct through the collection opening.

### BRIEF DESCRIPTION OF THE DRAWINGS

FIG. 1 is a diagrammatic illustration of a laser printer including a debris collection and exhaust duct in accordance with one embodiment of the invention coupled to a fume extraction system.

FIG. 2 is an isometric view of a label printer including a debris collection duct in accordance with one embodiment of the invention.

FIG. 3 is a isometric view of the label printer shown in FIG. 2 without the debris collection duct.

FIG. 4 is a side view of portions of the label printer shown in FIG. 2.

FIG. 5 is an isometric view of the debris collection duct shown in FIG. 2.

FIG. 6 is a diagrammatic illustration of the laser system shown in FIG. 2.

FIG. 7 is detailed isometric view of the collection duct latch assembly, shown from the side of the collection duct.

FIG. 8 is detailed isometric view of the collection duct latch assembly, shown from the side of the laser assembly opposite the collection duct.

### DETAILED DESCRIPTION

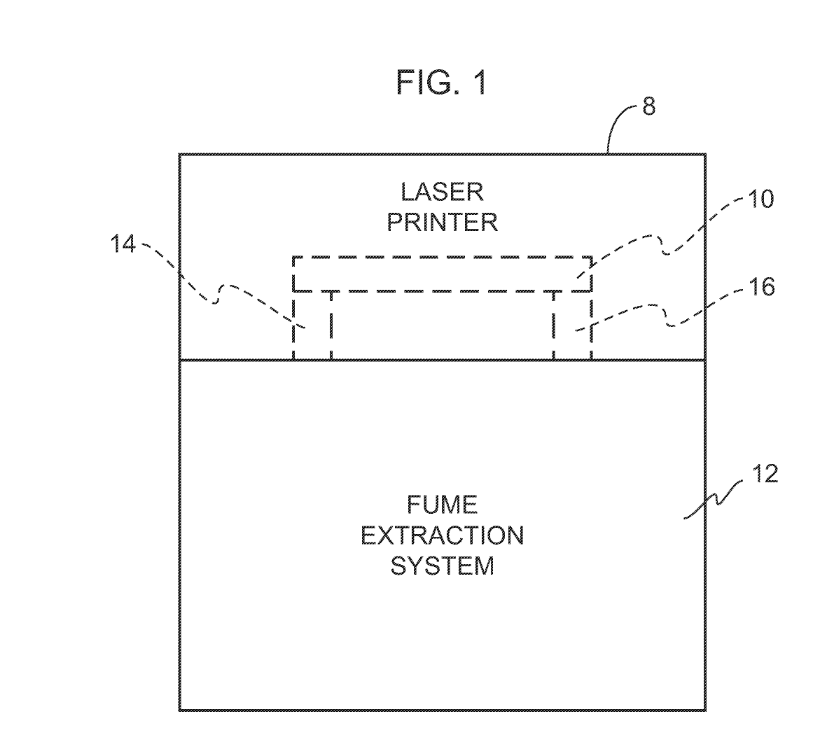

FIG. 1 is a diagrammatic illustration of a laser printer 8 that includes a disposable debris collection and exhaust duct 10 in accordance with an embodiment of the invention mounted to a fume extraction system 12. As shown, laser printer 8 also includes an input duct 14 and an output duct 16 that couple input and exhaust ports of the debris collection duct 10, respectively, to the fume extraction system 12. Fume extraction systems such as 12 are generally known and available from sources such as BOFA International Ltd and Quatro Air Technologies. The input duct 14 can be coupled to a source of relatively clean air (e.g., ambient air). Fume extraction system 12 generates a source of relatively low pressure at the output duct 16 that produces an exhaust air flow from the input duct 14 through the debris collection duct 10. Debris such as gasses, fumes and particulate produced by the laser printer 8 are collected in and exhausted by the debris collection duct 10. In some embodiments of the invention the fume extraction system 12 filters the debris collected by the duct 10.

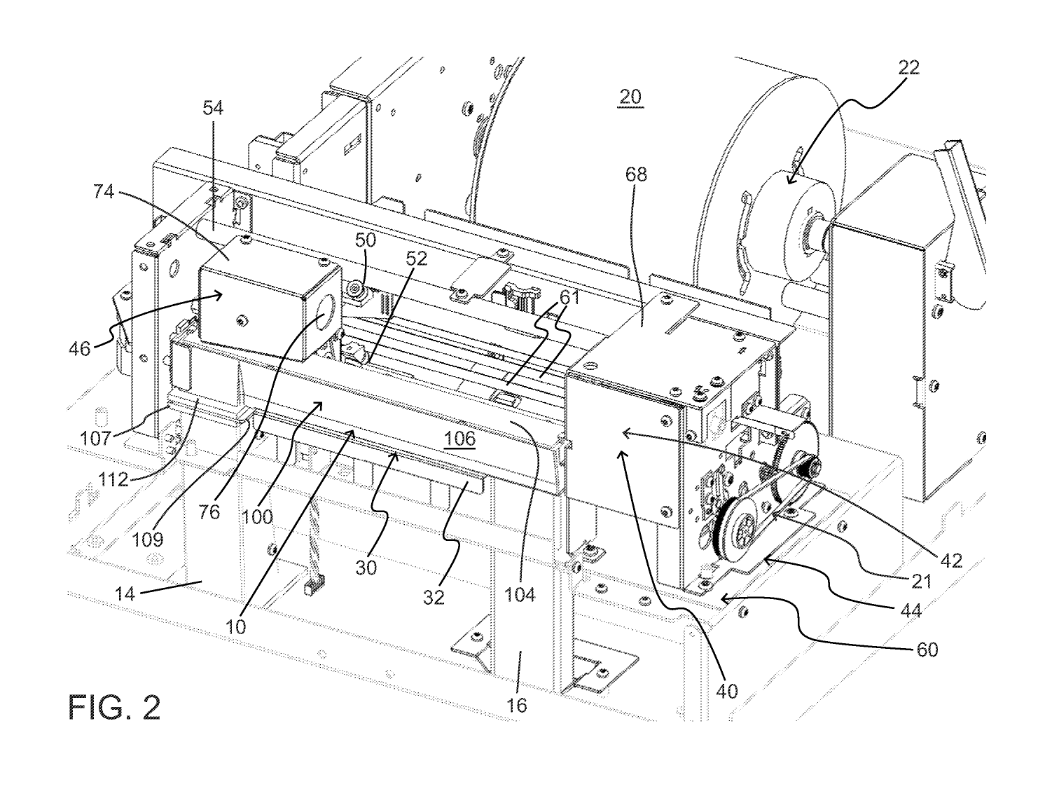

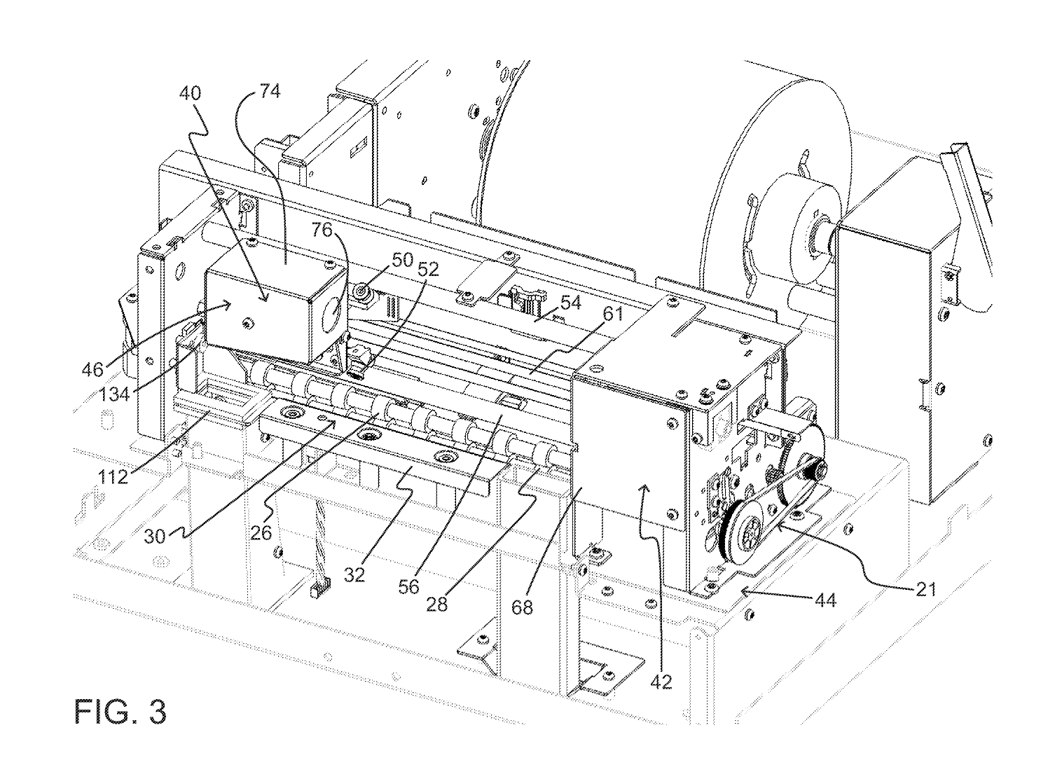

FIGS. 2-5 illustrate in greater detail one embodiment of laser printer 8 and debris collection duct 10. In this embodiment the laser printer 8 is a label printer that prints directly onto ablation-type label medium or stock 20. Stock 20 can be provided in the form of a roll that is mounted to a reel-type material receiving structure 22. A drive mechanism 21 including pinch rollers 26 and 28 causes the stock 20 to be fed to and driven through an elongated imaging region 30. The stock 20 is supported at the imaging region 30 by a support plate 32 in the illustrated embodiment.

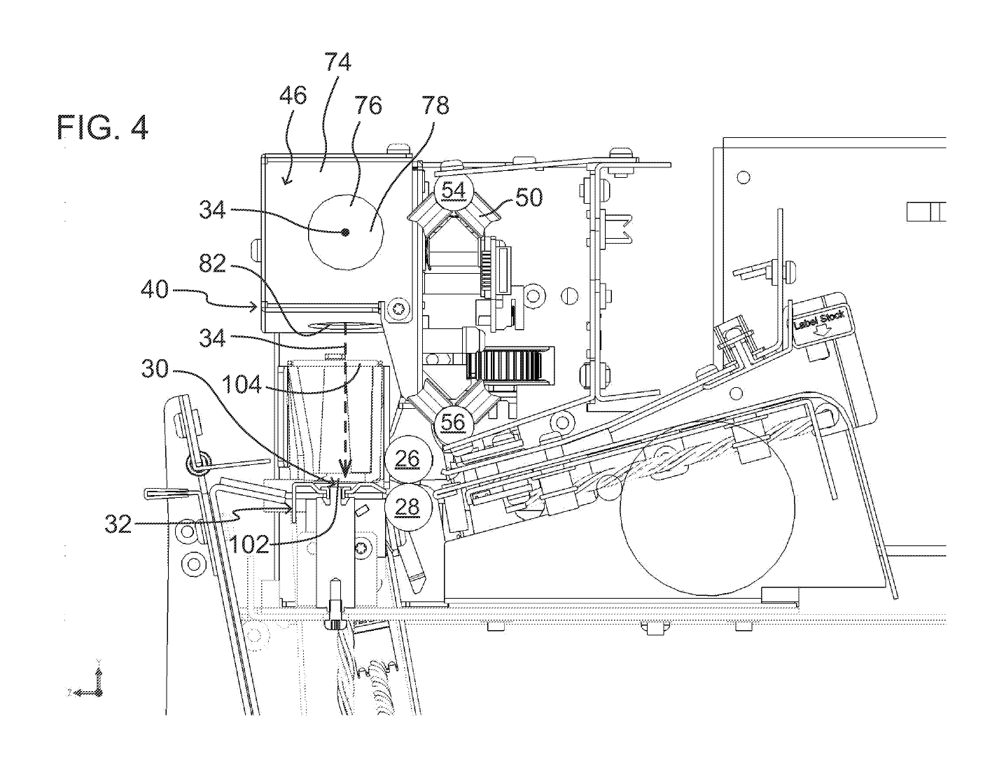

The laser beam (shown e.g., at 34 in FIG. 4) is produced and scanned or otherwise driven across the imaging region 30 by a laser system 40. In the illustrated embodiment the laser system 40 includes a laser assembly 42 that is fixedly mounted to the base 44 of the printer 8 and a scanning carriage 46. Scanning carriage 46 is mounted for reciprocal movement along the imaging region 30 to scan the laser beam 34 across the stock 20 as the stock is driven through the imaging region. In the illustrated embodiment the scanning carriage 46 includes a pair of upper support rollers 50 and a pair of lower support rollers 52 that support the carriage for motion on upper and lower guide bars 54 and 56, respectively, that are mounted with respect to the base 44. The scanning carriage 46 is driven by carriage drive motor assembly 60 coupled to the scanning carriage by a belt 61.

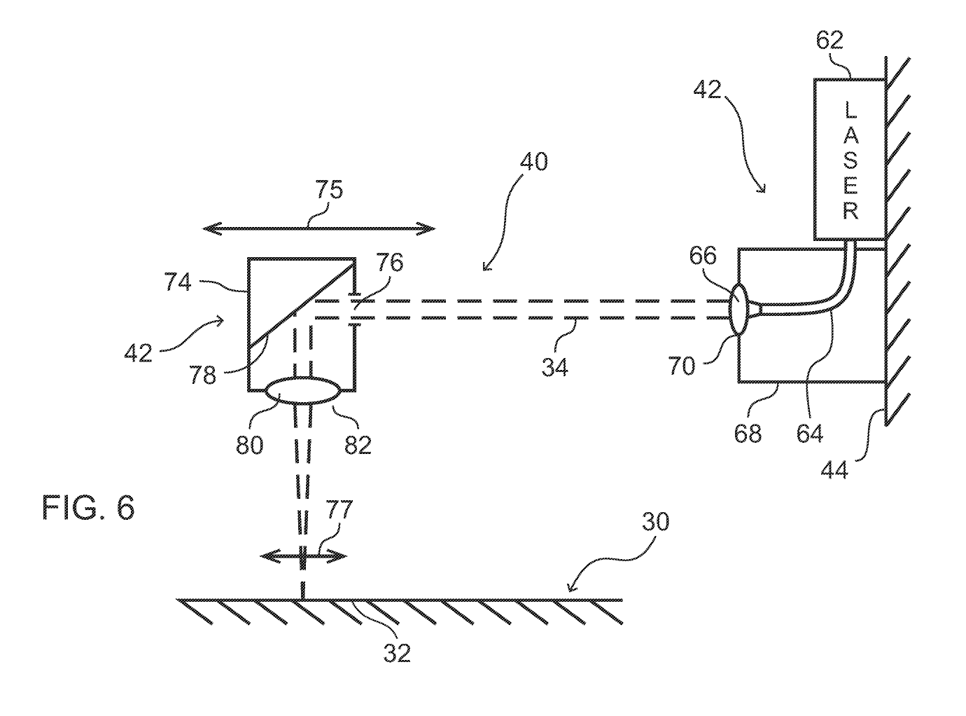

Laser system 40 and its operation can be described in greater detail with reference to FIG. 6, where the laser assembly 42 and scanning carriage 46 are shown. The laser assembly 42 includes a laser 62, optical fiber 64 and collimating lens 66 mounted with respect to the base 44. Lens 66 is mounted within an enclosure 68. The laser beam 34 produced by laser 62 is coupled to the lens 66 which collimates the beam and directs the beam to the scanning carriage 46 though an opening 70 in the housing 68. The scanning carriage 46 includes a housing 74 having an input opening 76, a beam redirection device such as mirror 78 and a focusing lens 80 in an output opening 82. As the scanning carriage 46 moves (indicated by line 75), the laser beam 34 is received at the input opening 76, directed by the mirror 78 to the lens 80, and focused onto and scanned across the imaging region 30 (indicated by line 77).

Debris collection duct 10 and its operation can be described in greater detail with reference to FIGS. 2-5. As shown, the debris collection duct 10 is positioned between the scanning carriage 46 and the imaging region 30. During the imaging and scanning processes described above, the laser beam 34 passes through the debris collection duct 10, and the duct collects and exhausts the gasses, fumes, particulate and other debris that is produced. The illustrated embodiment of debris collection duct 10 has an elongated tubular collection region 100 having a collection opening 102 on a first or bottom side and a laser beam window 104 on a second or top side opposite the collection region from the collection opening. Side walls 106 extend between the collection opening 102 and the laser beam window 104. An input port 108 and exhaust port 110 are located on opposite sides or ends of the duct 10 and the collection region 100. Laser beam window 104 is an opening in the duct 10 that receives the laser beam 34, and in the illustrated embodiment is enclosed by a generally clear glass or plastic member that is relatively transparent to the laser beam.

As perhaps best shown in FIGS. 2 and 4, the debris collection duct 10 is located in the printer 8 with the collection opening 102 extending along the image region 30 close to the location at which the laser beam is imaged onto the stock 20. In one embodiment, springs (not shown in the FIGS.) bias the support plate 32 toward the duct 10 to urge the stock 20 into communication with the portions of the duct forming the collection opening 102. In other embodiments (not shown) the edge of the duct 10 defining the collection opening 102 can be located close to but spaced a short distance from the stock 20 at the imaging region 30.

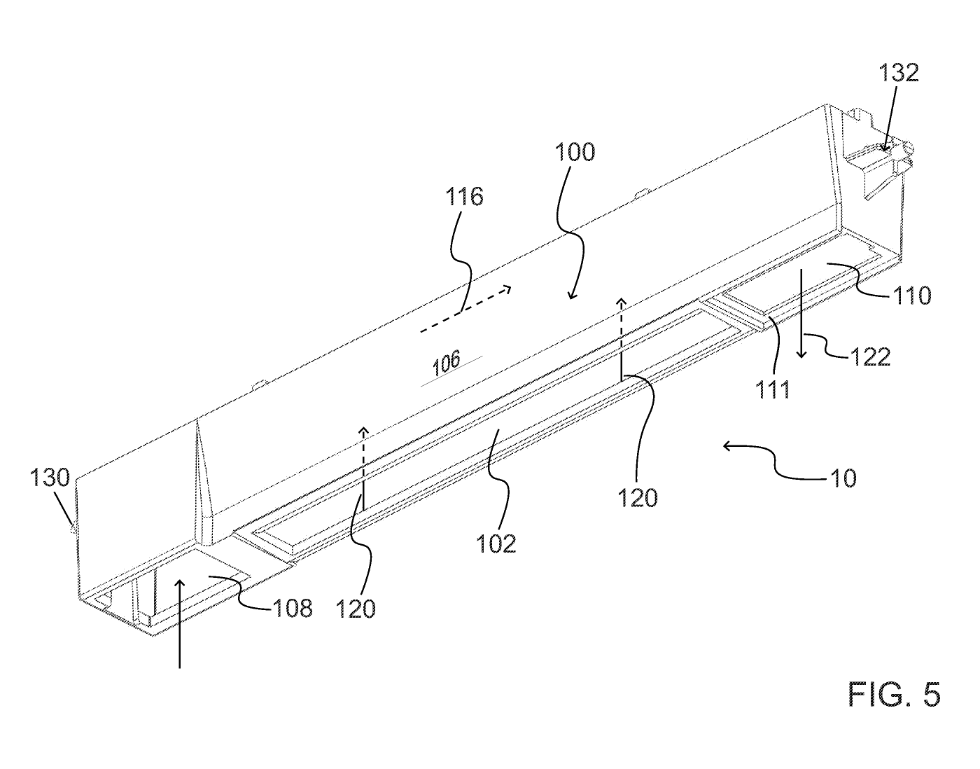

Input port 108 is mated with and coupled to the input duct 14, while the exhaust port 110 mates with and is coupled to the exhaust duct 16. Foam or other gaskets can be used to enhance the mechanical coupling and relatively air-tight nature of the seal between the input port 108 and input duct 14, and between the exhaust port 110 and exhaust duct 16. In the illustrated embodiment of the invention a ring-shaped plate 109 mounted with respect to the base 44 of the printer 8 has its opening (not visible in the FIGS.) aligned with the input port 108 of collection duct 10 and the input duct 14. A gasket 112 is located between the plate 109 and input port 108 of collection duct 10. A gasket 107 is located between the plate 109 and input duct 14. The gaskets 107 and 112 can be compliant to enhance the coupling of the debris collection duct 10 and input duct 14. Although not shown in the FIGS., a gasket similar to gaskets 107 and 112 can couple the exhaust port 110 of collection duct 10 to the exhaust duct 16 in a similar manner and for similar purposes. In the embodiment illustrated in FIG. 5 the exhaust port 110 includes a recess 111 to seat the gasket.

The fume extraction system 12 generates an exhaust air flow through collection region 100. The exhaust air flow is in a generally linear direction along a path indicated by arrow 116 that is parallel to the length of the collection region. In the illustrated embodiment the input port 108 and exhaust port 110 open on the bottom side of the debris collection duct 10, in a direction generally perpendicular to the direction of the exhaust air flow in the collection region 100. In other embodiments (not shown), the input and/or output ports can open in other directions, such as on the sides or ends of the duct 10. As indicated by arrow 118, ambient or other input air from input duct 14 is drawn into the input port 108 and forms part of the exhaust air flow. Debris from the printing operation, including a debris air flow indicated by arrows 120, will be drawn into the duct 10 through the collection opening 102 and become part of the exhaust air flow. The exhaust air flow including the collected debris exits the duct 10 and enters the exhaust duct 16 though the exhaust port 110 as indicated by arrow 122. The laser beam 34 passes through the duct 10 on a linear path in a direction generally perpendicular to the exhaust air flow.

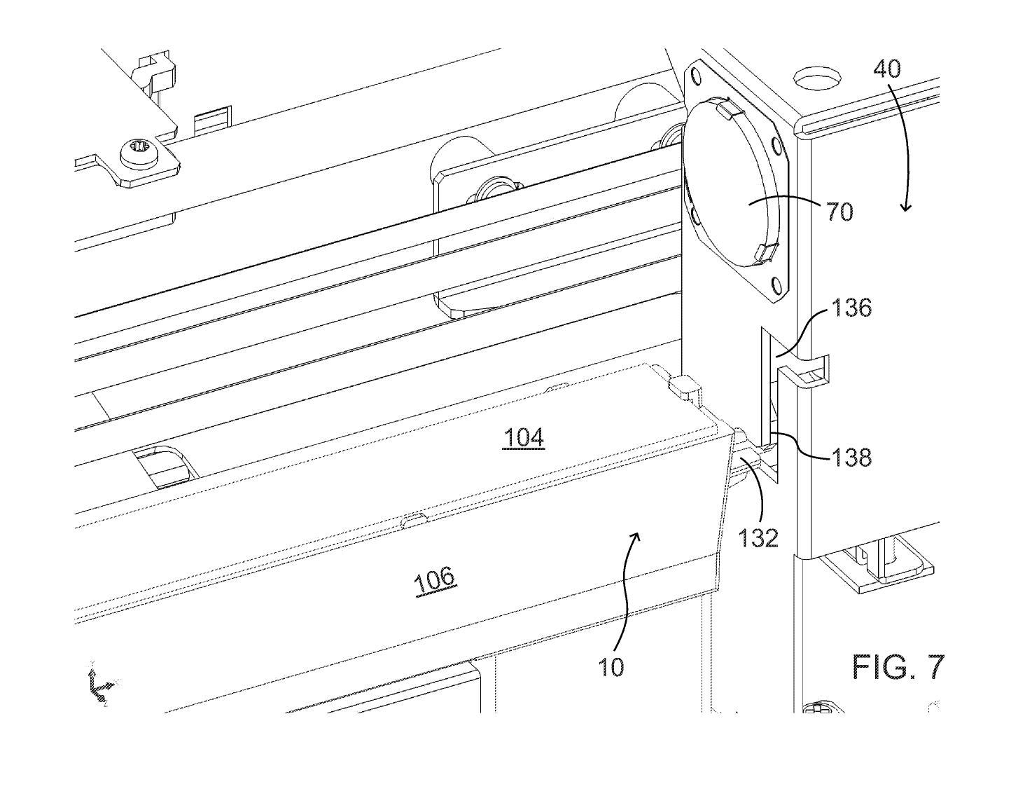

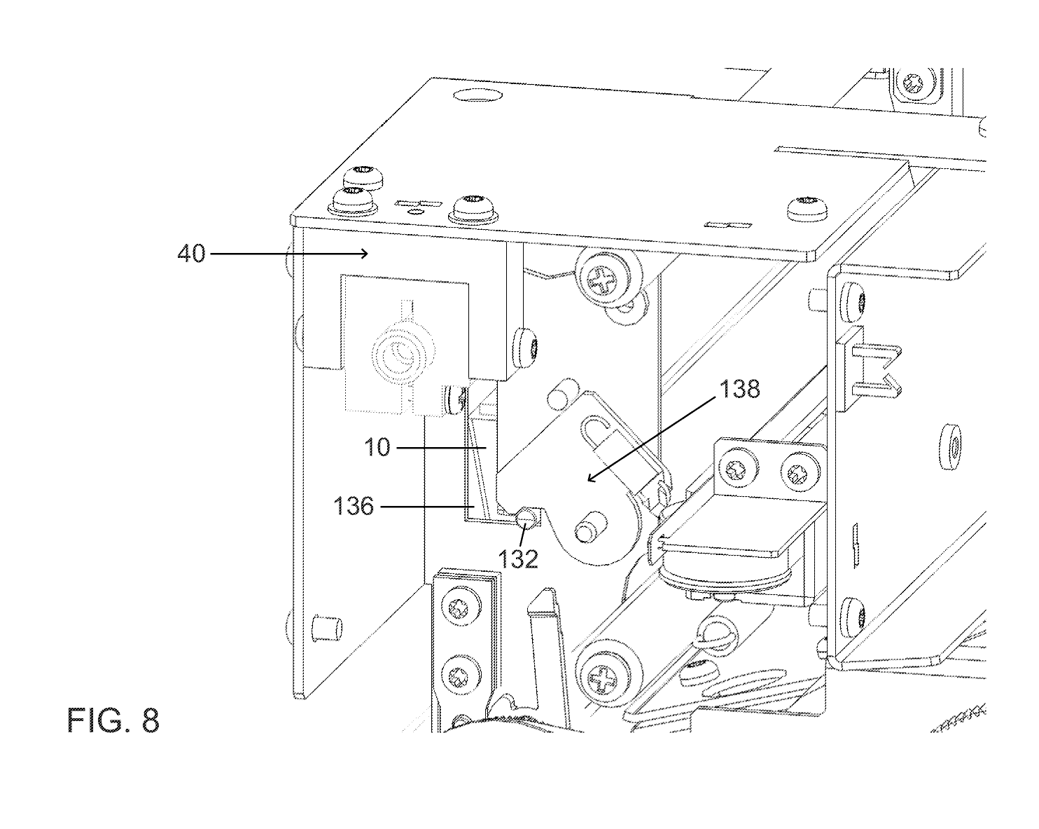

In the illustrated embodiment, debris collection duct 10 is configured to be conveniently removably mounted in the printer 8. To facilitate the removable mounting the illustrated embodiment of collection duct 10 includes mounting pins 130 on one end (e.g., the end with input port 108) and a latch tab 132 on the opposite end. The mounting pins 130 are received by apertures 134 on the printer 8. As shown in FIGS. 7 and 8, the latch tab 132 engages a support channel 136 on the printer, and is releasably latched into the support channel by spring-biased latch 138. This mounting structure enables the debris collection duct 10 to be inserted into and removed from the printer 10 by hand without the use of tools. Other structures (not shown) for removably mounting the duct 10 in the printer can be used in other embodiments. In yet other embodiments (not shown) the duct is relatively permanently mounted in the printer (e.g., may need the use of tools to be mounted and removed). In some embodiments of the invention the debris collection duct is intended to be disposed and replaced if debris builds up on interior surfaces of the duct. In other embodiments, the exhaust duct 16 is also configured to be conveniently removably mounted in the printer 8 to enable cleaning and/or replacement.

Although the invention is described in connection with a number of embodiments, those skilled in the art will recognize that changes can be made in form and detail without departing from the spirit and scope of the invention. For example, although described in connection with a label printer, the duct can be use in other laser-based imaging devices such as those including electrostatic drums. The duct need not be removable or disposable. Although the duct is described as an elongated member that enables the laser beam to be scanned across the duct, in other embodiments the laser beam is stationary with respect to the duct and relative movement between the laser beam and the stock being printed is provided by other approaches.

1. An image forming device, including:
an imaging region having a length at which a laser beam is imaged onto a medium;
a debris collection duct to collect debris produced when the laser beam is imaged onto the medium, the debris collection duct comprising a collection region having a laser beam window extending across the length of the imaging region and a collection opening in communication with the imaging region, wherein debris can enter the duct through the collection opening; and
a laser system for scanning the laser beam across the length of the imaging region through the laser beam window of the debris collection duct.

2. The image forming device of claim 1 wherein the debris collection duct further includes an exhaust port in communication with the collection region.

3. The image forming device of claim 2 wherein the collection region defines an exhaust path extending in a first and optionally linear direction, and the exhaust port opens at an angle with respect to the exhaust path, and wherein the angle is optionally about 90°.

4. The image forming device of claim 3 wherein the exhaust port is configured to be coupled to a source of relatively low pressure and/or to a fume extraction system.

5. The image forming device of claim 4 and further including an output duct to couple the exhaust port to a source of relatively low pressure and/or to a fume extraction system.

6. The image forming device of claim 5 wherein the debris collection duct is configured to be conveniently removably mounted, and optionally without the use of tools, to the image forming device and coupled to the output duct.

7. The image forming device of claim 1 wherein the debris collection duct further includes an input port.

8. The image forming device of claim 7 wherein the collection region defines an exhaust path extending in a first and optionally linear direction, and the input port opens at an angle with respect to the exhaust path, and wherein the angle is optionally about 90°.

9. The image forming device of claim 8 wherein the input port is configured to be coupled to a source of relatively high pressure, relatively clean air and/or to a fume extraction system.

10.-11. (canceled)

12. The image forming device of claim 1 wherein the debris collection duct includes an exhaust port and an input port on opposite ends of the collection region.

13. The image forming device of claim 1 wherein the debris collection duct is generally tubular and defines an exhaust path extending in a first and optionally linear direction.

14. The image forming device of claim 13 wherein the collection opening is an elongate opening generally parallel to the exhaust path and the laser system scans the laser beam through the collection opening.

15. The image forming device of claim 14 wherein the laser beam window and collection opening are on opposite sides, and optionally top and bottom sides, of the collection region.

16. The image forming device of claim 15 wherein the laser beam window is an elongate window generally parallel to the exhaust path.

17. The image forming device of claim 1 wherein the debris collection duct is generally tubular and defines an exhaust path extending in a first, and optionally linear direction, and the laser beam window and collection opening are spaced from one another about a direction generally perpendicular to the exhaust path.

18. (canceled)

19. The image forming device of claim 1 wherein the laser beam is imaged onto the imaging region along a linear path through the collection duct.

20. (canceled)

21. The image forming device of claim 1 wherein the laser beam window is covered by material such as plastic or glass that is relatively transparent to the laser beam.

22. (canceled)

23. The image forming device of claim 1 wherein the debris collection duct is configured to be conveniently removably mounted, and optionally without the use of tools, to the image forming device.

24.-32. (canceled)

33. A debris collection duct for use in an image forming device of the type having a laser system for scanning a laser beam across a length of an imaging region, comprising:
a tubular collection region;
a laser beam window in the collection region to extend across the length of the imaging region, wherein the scanning system can scan the laser beam onto the imaging region through the laser beam window;
a collection opening in the collection region for communication with the imaging region, wherein debris can enter the collection duct through the collection opening; and
an exhaust port in communication with the collection region.

34. The debris collection duct of claim 33 and further including an input port in communication with the collection region.
